(19) United States
(12) Patent Application Publication
(10) Pub. No.: US 2009/0015490 A1
(43) Pub. Date: Jan. 15, 2009

(54) ELECTRONIC DEVICE AND METHOD FOR MANUFACTURING SAME

(76) Inventors: Satoru HONDA, Kanagawa-ken (JP); Tomoko Honda, Kanagawa-ken (JP); Nobuyoshi Kuroiwa, Kanagawa-ken (JP); Masaomi Nakahata, Kanagawa-ken (JP); Jun Morimoto, Kanagawa-ken (JP); Yoshikazu Hata, Kanagawa-ken (JP); Koichi Sato, Tokyo (JP); Akihiro Tsujimura, Tokyo (JP); Makoto Tabata, Tokyo (JP); Minoru Sakurai, Tokyo (JP); Shoji Kato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/171,592

(22) Filed: Jul. 11, 2008

(30) Foreign Application Priority Data
Jul. 13, 2007 (JP) 2007-184385

(51) Int. Cl. H01Q 1/24; H01Q 1/40

(52) U.S. Cl. 343/702; 343/873

(57) ABSTRACT

An electronic device includes: a first molded body having a recessed cross section and made of resin; a second molded body having a recessed cross section and made of resin, the second molded body being fitted inside the first molded body; and an antenna pattern sandwiched between the first and second molded body. Among the surfaces of the first molded body, the surface on the side not adjacent to the antenna pattern constitutes an outer surface.

### CROSS-REFERENCE TO RELATED APPLICATIONS

This application is based upon and claims the benefit of priority from the prior Japanese Patent Application No. 2007-184385, filed on Jul. 13, 2007; the entire contents of which are incorporated herein by reference.

### BACKGROUND OF THE INVENTION

1. Field of the Invention

This invention relates to an electronic device and a method for manufacturing the same.

2. Background Art

There is a strong demand for downsizing electronic devices such as mobile phones and PDAs (personal digital assistants). Improvement of the enclosure structure is needed for the downsizing while reducing the influence of noise from the integrated circuit and high-frequency circuit exerted on the antenna.

In this case, a structure can be contemplated in which the antenna is placed on the enclosure side, away from the substrate populated with the integrated circuit and high-frequency circuit. Placing the antenna on the outer surface side of the enclosure constrains the design, and may also change the antenna characteristics when a human body comes close thereto. Hence, more preferably, the antenna is placed on the inner surface side of the enclosure.

However, the inner surface side of the enclosure is often provided with a rib structure to ensure adequate stiffness, and also often provided with bosses for placing components. Placing the antenna pattern on the inner surface side of the enclosure provided with ribs and bosses constrains the shape.

JP-A 11-187096(Kokai) (1999) discloses a linear antenna placed like a loop around the liquid crystal display window of a mobile phone to save space for installing the antenna.

### SUMMARY OF THE INVENTION

According to an aspect of the invention, there is provided an electronic device including: a first molded body having a recessed cross section and made of resin; a second molded body having a recessed cross section and made of resin, the second molded body being fitted inside the first molded body; and an antenna pattern sandwiched between the first and second molded body, among the surfaces of the first molded body, the surface on the side not adjacent to the antenna pattern constituting an outer surface.

According to another aspect of the invention, there is provided a method for manufacturing an electronic device, including: forming a first molded body having a recessed cross section and made of resin; inserting an antenna pattern inside the first molded body; forming a second molded body having a recessed cross section and made of resin; and fitting the second molded body inside the first molded body configured to sandwich the antenna pattern.

According to still an aspect of the invention, there is provided a method for manufacturing an electronic device, including: forming an antenna pattern on a surface of a second molded body made of resin by one of printing, plating, conductive material coating, and evaporation; and forming a first molded body having a recessed cross section and made of resin outside the second molded body configured to sandwich the antenna pattern, the second molded body being shaped to have a recessed cross section.

### BRIEF DESCRIPTION OF THE DRAWINGS

FIGS. 1A and 1B are schematic views showing an electronic device according to an embodiment of the invention;

FIG. 2A is a schematic cross-sectional view showing a first example of the enclosure integrated antenna of the electronic device according to this embodiment, and FIG. 2B is an enlarged view of the portion A in FIG. 2A;

FIG. 3 is a flow chart of a manufacturing process of the first example;

FIG. 4 is a schematic cross-sectional view showing a variation of the first example;

FIG. 5A is a schematic cross-sectional view showing a second example of the enclosure integrated antenna, and FIG. 5B is an enlarged view of the portion B in FIG. 5A;

FIG. 6 is a flow chart of a manufacturing process of the second example;

FIG. 7 is a schematic cross-sectional view showing a third example of the enclosure integrated antenna;

FIG. 8 is a flow chart of the manufacturing process of the third example;

FIG. 9A is a schematic cross-sectional view showing a fourth example of the enclosure integrated antenna, and FIG. 9B is an enlarged view of the portion C in FIG. 9A; and

FIGS. 10A to 10D are schematic views showing the configuration of the antenna.

### DETAILED DESCRIPTION OF THE INVENTION

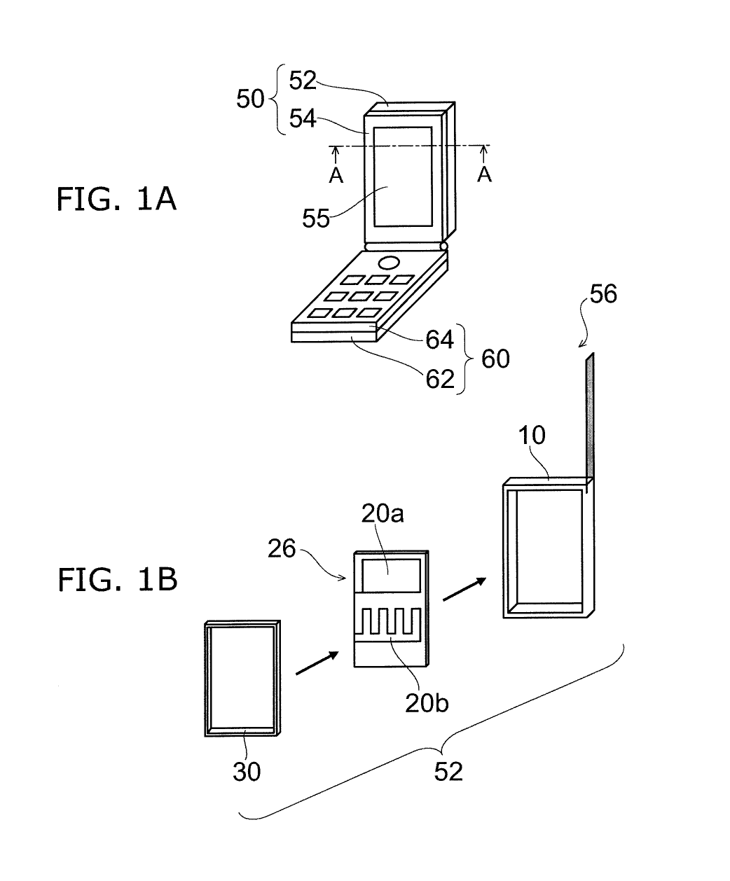

An embodiment of the invention will now be described with reference to the drawings. FIG. 1 is a schematic view showing an electronic device according to the embodiment of the invention, in which FIG. 1A is a schematic perspective view, and FIG. 1B is a schematic view showing the configuration of the enclosure.

FIG. 1 shows an electronic device, which is a folding mobile phone. Naturally, instead, it can be a sliding electronic device. The upper enclosure 50 includes an outer enclosure 52 and an inner enclosure 54. The outer enclosure 52 is located outside when the folding mobile phone is folded. That is, it constitutes part of the outside design surface of the mobile phone when it is folded. On the other hand, the inner enclosure 54 is located inside when the folding mobile phone is folded. That is, it does not substantially constitute the outside design surface of the mobile phone when it is folded.

The outer enclosure 52 is provided outside as viewed from the user in normal use. On the other hand, the inner enclosure 54 is provided inside as viewed from the user, that is, on the user's side, in normal use. The inner enclosure 54 is populated with at least one of an image display section such as a liquid crystal display 55 and a manipulation section.

The lower enclosure 60 includes an outer enclosure 62 and an inner enclosure 64. To the outer enclosure 62, a substrate populated with a high-frequency circuit including a power feeder unit, a signal processing circuit, a control circuit, and a power supply circuit, and a secondary battery are fixed. The inner enclosure 64 is populated with a keyboard and the like.

FIG. 1B is a schematic view showing the configuration of the outer enclosure 52 constituting the upper enclosure 50. The outer surface 56 of the outer enclosure 52 is the design surface. Its appearance in the closed state of the electronic device is important. An antenna pattern layer 26 is placed inside a first molded body 10. The antenna pattern layer 26 illustratively includes two antenna patterns 20a, 20b, a protection film for the antenna pattern, and an insulating film.

The antenna pattern layer 26 is sandwiched between the first molded body 10 and a second molded body 30, constituting a three-layer structure integrated with the enclosure. The first and second enclosure 10, 30 are formed by molding using a resin material, for example. The outer enclosure 52 can be formed in this manner.

According to this embodiment, an antenna pattern can be placed in a wide area on the inner surface of the outer enclosure 52. While two antenna patterns 20a, 20b are shown in FIG. 1B, more antenna patterns can be placed. Furthermore, the antenna shape can be designed more freely independent of the position of ribs and bosses inside the enclosure, hence allowing good antenna characteristics.

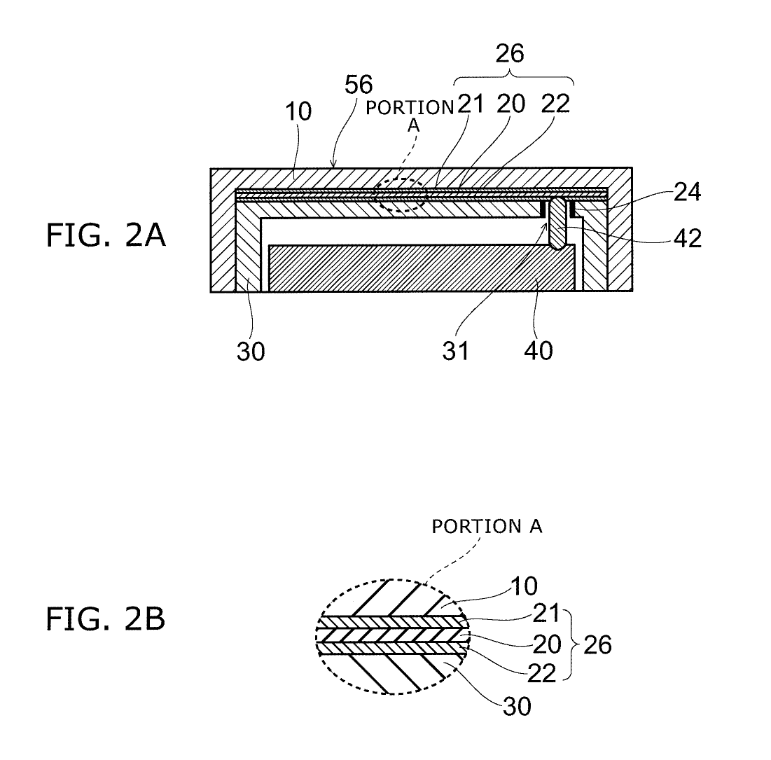

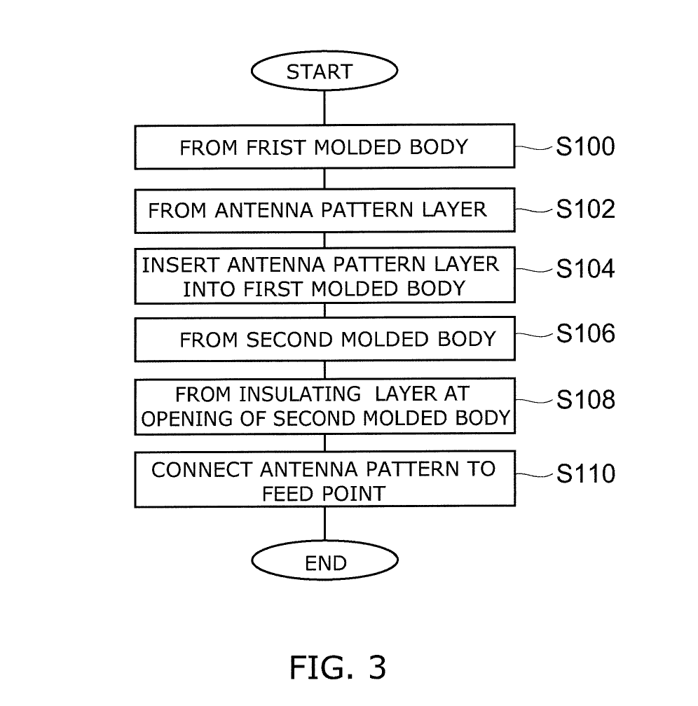

FIG. 2A is a schematic cross-sectional view showing a first example of the enclosure integrated antenna of the electronic device according to this embodiment, representing the cross section taken along the dot-dashed line AA in FIG. 1A. FIG. 2B is an enlarged view of the portion A in FIG. 2A. FIG. 3 is a flow chart showing a manufacturing process of the first example. The configuration and the manufacturing process of the first example are now described with reference to FIGS. 2 and 3. First, a first molded body 10 made of resin is molded (S100). Subsequently, a conductive layer is formed on a film by plating, evaporation, or printing to produce an antenna pattern layer 26 (S102).

The antenna pattern layer 26 is inserted into the first molded body 10, which has a recessed cross section and is made of resin (S104). Here, the antenna pattern protection film 21 can be the above-mentioned film, or can be additionally provided. Likewise, the insulating film 22 can be the above-mentioned film, or a resin sheet having a thickness of several micrometers. The insertion of the antenna pattern layer 26 is followed by forming a second molded body 30, which is made of resin and has a recessed cross section (S106). Thus, an enclosure integrated antenna is completed. Here, alternatively, the second molded body 30 can be formed beforehand and fitted into the first molded body 10, and then they can be bonded or welded.

In FIG. 2, the second molded body 30 can be made of a conductive resin to serve as an electromagnetic shielding layer, which can shield noise from the power supply unit 40 such as the liquid crystal display section or the substrate to improve antenna characteristics. In this case, to prevent the feed point 42 from being in contact with the second molded body 30, which is conductive, an insulating layer 24 is provided on the sidewall of the opening 31 of the second molded body 30 surrounding the feed point 42 (S108). If the second molded body 30 is made of an insulating material, the insulating film 22 and the insulating layer 24 can be omitted.

The power supply unit 40 including the substrate or the liquid crystal display section is connected to the antenna pattern through the feed point 42 (S110).

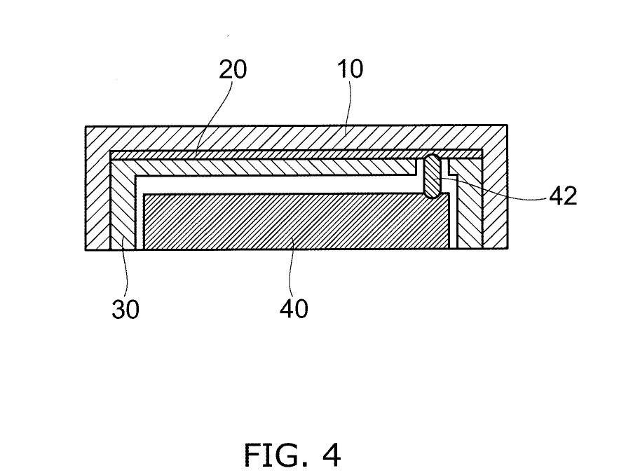

The antenna pattern layer 26 can be a thin stamped sheet metal. FIG. 4 is a schematic cross-sectional view of an enclosure integrated antenna with an antenna pattern 20 made of a sheet metal according to a variation of the first example. In the following figures, the same components as those in FIG. 2 are labeled with like reference numerals, and the detailed description thereof is omitted. In this variation, the protection film 21 can be omitted. This structure can simplify the manufacturing process.

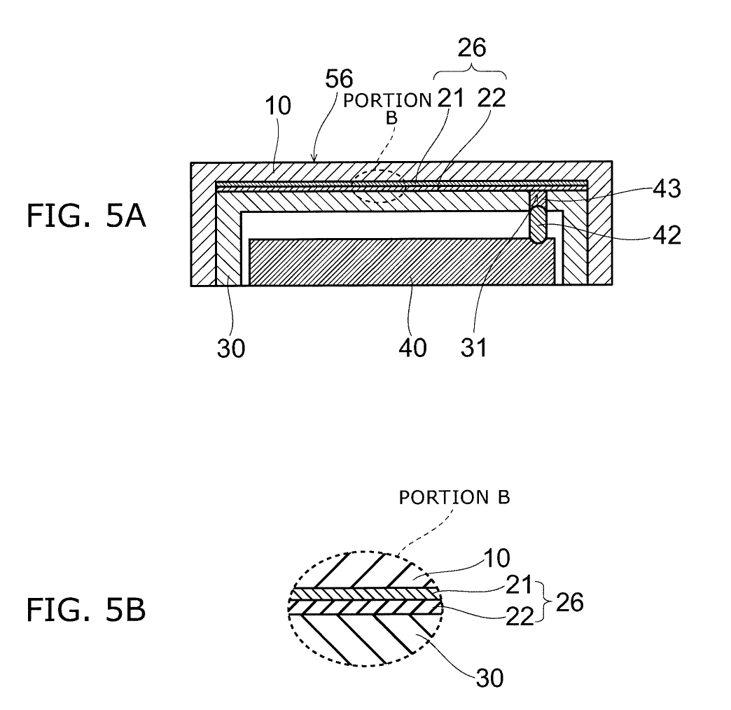

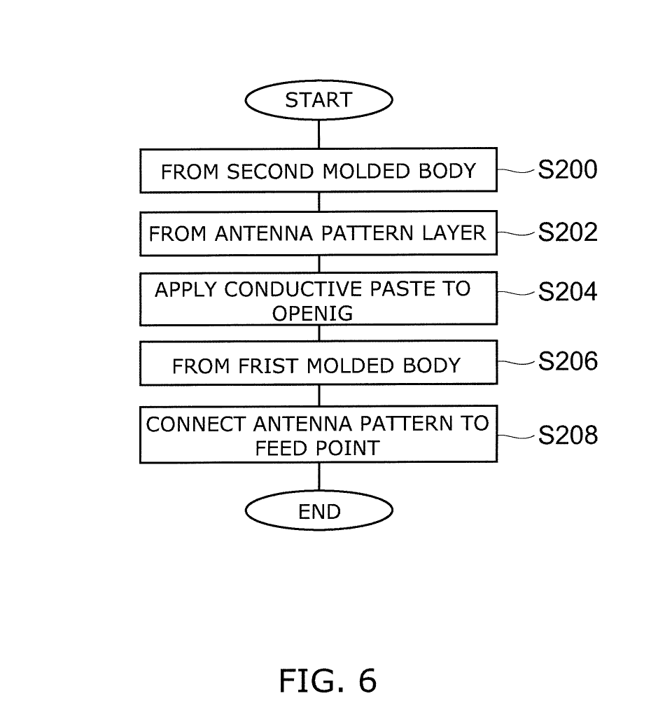

FIG. 5A is a schematic cross-sectional view showing a second example of the enclosure integrated antenna, and FIG. 5B is an enlarged view of the portion B in FIG. 5A. FIG. 6 is a flow chart showing the manufacturing process. In this case, a second molded body 30 made of resin is molded in advance (S200). An antenna pattern 20 is formed on the second molded body 30 by plating, evaporation, or printing, and an antenna pattern protection film 21 is formed further thereon to produce an antenna pattern layer 26 (S202).

A conductive paste 43 made of resin or the like is applied to the opening 31 to be connected to the feed point 42 (S204). Subsequently, a first molded body 10 is formed (S206), and the antenna pattern 20 is connected to the feed point 42 (S208).

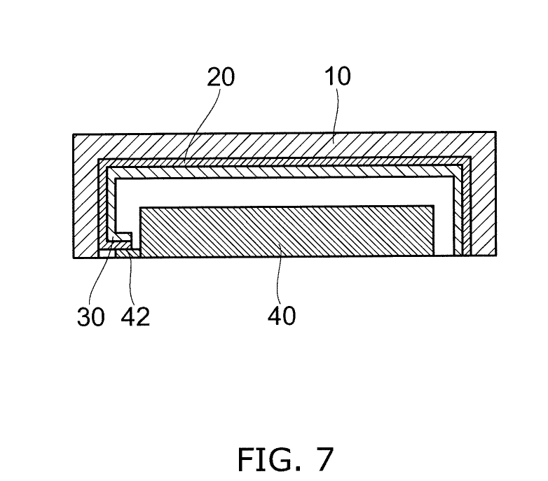

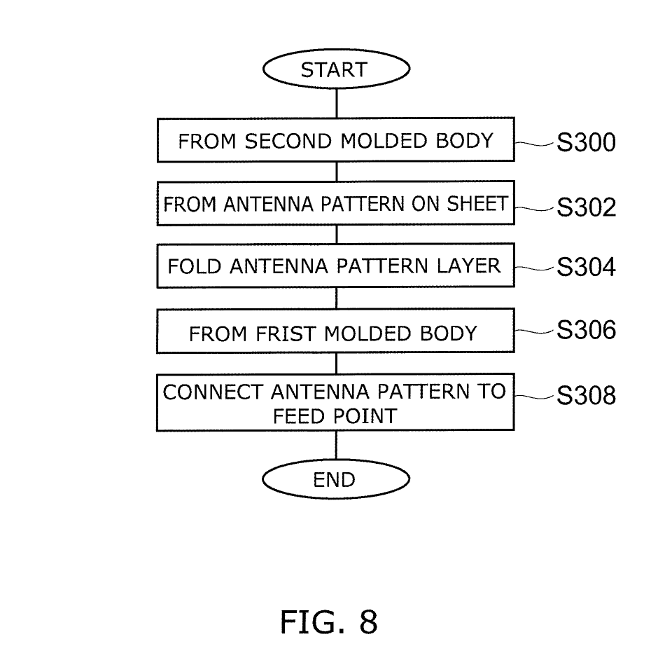

FIG. 7 is a schematic cross-sectional view showing a third example of the enclosure integrated antenna. FIG. 8 is a flow chart of the manufacturing process. The second molded body 30 is formed into a sheet made of an insulator (S300). An antenna pattern 20 is formed on the sheet by plating, evaporation, printing, or sheet metal bonding (S302).

Subsequently, the sheet is folded so that the antenna pattern 20 can be bonded to the first molded body 10 (S304), and the first molded body 10 is formed to cover the sheet (S306). The power supply unit 40 including the substrate or the liquid crystal display section is connected to the feed point 42 in this folded portion (S308).

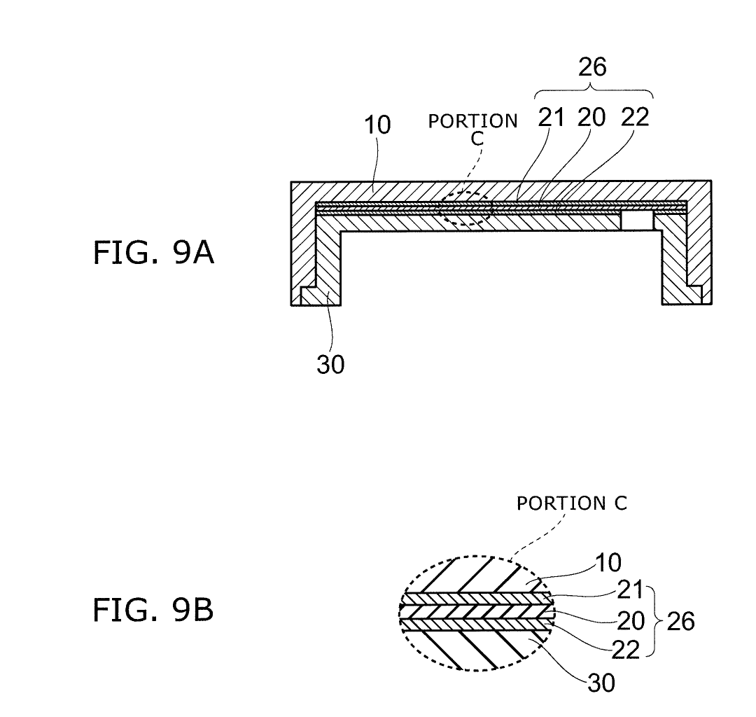

FIG. 9A is a schematic cross-sectional view showing a fourth example of the enclosure integrated antenna, and FIG. 9B is an enlarged view of the portion C in FIG. 9A. A first and second molded body 10, 30 made of resin are formed beforehand. An antenna pattern layer 26 is inserted into the first molded body 10, and the second molded body 30 is fitted therein. Then, the edges of the first and second molded body 10, 30 are fixed by bonding or supersonic welding to produce an outer enclosure 52.

In the electronic device based on the enclosure integrated antenna of the above first to fourth example, a wide area on the inner surface of the enclosure can be used for an antenna pattern region. Hence, the electronic device can be downsized while being equipped with antennas having different characteristics.

Furthermore, integration with the enclosure allows the antenna to be distanced from the substrate, and the influence of noise from the electronic components on the substrate can be reduced. Moreover, if the molded body on the substrate side is provided with a shielding effect, noise can be further reduced. Furthermore, this embodiment can prevent the antenna pattern from being disturbed by hands, and can avoid changing antenna characteristics such as directional characteristics.

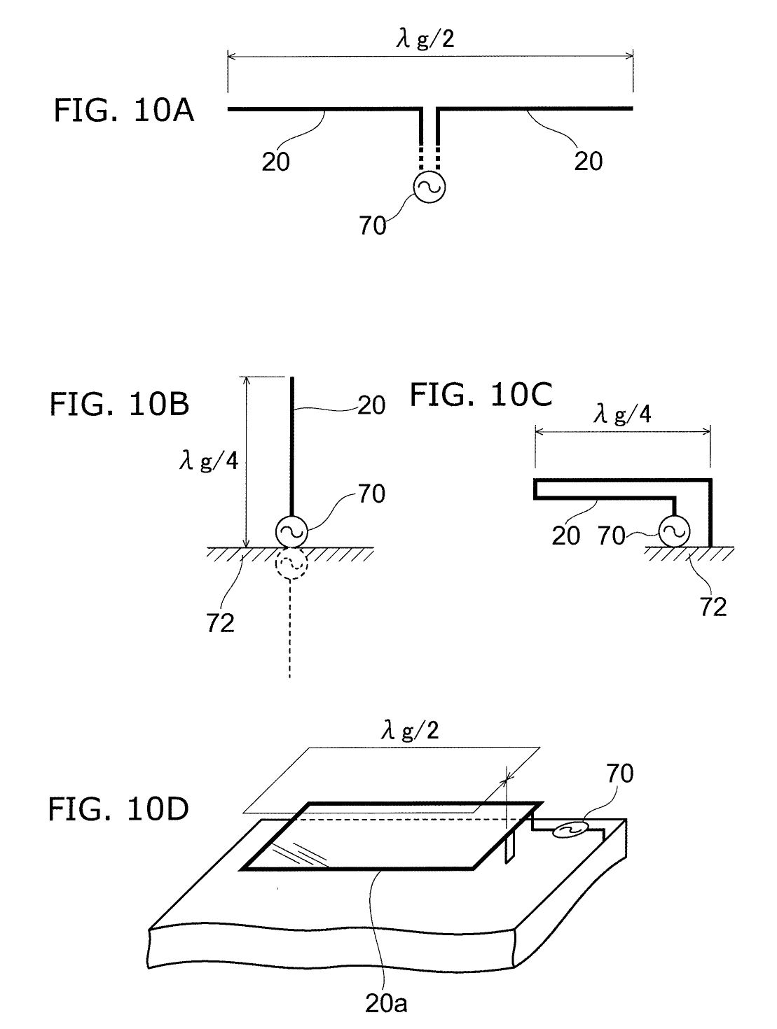

Here, a description is given of the antenna pattern 20. FIG. 10 is a schematic view showing an example antenna that can be used in this embodiment. FIG. 10A shows a dipole antenna. The antenna pattern 20 has a length of generally a half wavelength and is excited at its middle portion by a feeder unit 70.

FIG. 10B shows a monopole antenna. The antenna pattern 20 has a length of generally a quarter wavelength. It can be treated similarly to a half-wavelength antenna by considering the ground plane 72.

FIG. 10C shows a folded dipole antenna, allowing high radiation efficiency based on high impedance.

FIG. 10D shows an inverted-F antenna having a plate-like element 20a, which has a perimeter length of generally a half wavelength. In this case, because the antenna excites the casing and passes a current therethrough, the effective size of the antenna can be increased.

Antennas selected from the group including the antenna patterns 20 illustrated in FIG. 10 can be placed on the outer enclosure 52 as shown in FIG. 1B to allow multi-band operation. More specifically, transmitting and receiving operations can be extended to the mobile phone triple band including GSM (Global System for Mobile communications), DCS (Digital Cellular System), and PCS (Personal Communications Service), as well as wireless LAN, FM and AM broadcasting, GPS (global positioning system), terrestrial digital broadcasting called One Seg, and electronic payment such as Felica™ and SUICA™. Such multiple types of antennas are difficult to install in the case of the rod antenna exposed to the outside of the enclosure.

The embodiment of the invention has been described with reference to the drawings. However, the invention is not limited thereto. The material, shape, size, and placement of the antenna pattern, molded body, substrate, insulating film, and enclosure constituting the electronic device can be variously modified by those skilled in the art without departing from the spirit of the invention, and such modifications are also encompassed within the scope of the invention.

1. An electronic device comprising:
a first molded body having a recessed cross section and made of resin;
a second molded body having a recessed cross section and made of resin, the second molded body being fitted inside the first molded body; and
an antenna pattern sandwiched between the first and second molded body,
among the surfaces of the first molded body, the surface on the side not adjacent to the antenna pattern constituting an outer surface.

2. The electronic device according to claim 1, wherein the second molded body is conductive, and an insulating film is provided between the second molded body and the antenna pattern.

3. The electronic device according to claim 2, wherein the second molded body has an opening with an insulating layer formed on its sidewall, and can be insulated from a feed point serving to feed power to the antenna pattern.

4. The electronic device according to claim 1, wherein a protection film is provided between the antenna pattern and the first molded body.

5. The electronic device according to claim 2, wherein the antenna pattern is a conductive layer formed on the insulating film which is shaped like a film.

6. The electronic device according to claim 4, wherein the antenna pattern is a conductive layer formed on the protection film which is shaped like a film.

7. The electronic device according to claim 1, wherein the antenna pattern is made of a sheet metal.

8. The electronic device according to claim 2, wherein the antenna pattern is made of a sheet metal.

9. The electronic device according to claim 1, wherein
the second molded body is made of an insulative film, and
the antenna pattern is a conductive layer formed on the insulative film and has a folded portion to be connected to a feed point.

10. The electronic device according to claim 1, wherein the second molded body has an opening, and the antenna pattern is electrically connected to a feed point through a conductive adhesive applied to the opening.

11. The electronic device according to claim 1, wherein the edge of the first molded body is fixed to the edge of the second molded body.

12. The electronic device according to claim 2, wherein the edge of the first molded body is fixed to the edge of the second molded body.

13. The electronic device according to claim 1, wherein the antenna pattern is one of a monopole antenna, a dipole antenna, and an antenna including a plate-like element.

14. The electronic device according to claim 2, wherein the antenna pattern is one of a monopole antenna, a dipole antenna, and an antenna including a plate-like element.

15. A method for manufacturing an electronic device, comprising:
forming a first molded body having a recessed cross section and made of resin;
inserting an antenna pattern inside the first molded body;
forming a second molded body having a recessed cross section and made of resin; and
fitting the second molded body inside the first molded body configured to sandwich the antenna pattern.

16. The method for manufacturing an electronic device according to claim 15, further comprising:
bonding between the edge of the first molded body and the edge of the second molded body.

17. The method for manufacturing an electronic device according to claim 15, wherein the antenna pattern is formed on an insulative film by one of printing, plating, conductive material coating, and evaporation.

18. A method for manufacturing an electronic device, comprising:
forming an antenna pattern on a surface of a second molded body made of resin by one of printing, plating, conductive material coating, and evaporation; and
forming a first molded body having a recessed cross section and made of resin outside the second molded body configured to sandwich the antenna pattern, the second molded body being shaped to have a recessed cross section.

19. The method for manufacturing an electronic device according to claim 18, further comprising:
before forming the first molded body, applying a conductive adhesive to an opening of the second molded body; and
after forming the first molded body, electrically connecting the antenna pattern to a feed point through the conductive adhesive.

20. The method for manufacturing an electronic device according to claim 18, further comprising:
forming the second molded body into a sheet, folding inward the edge of the second molded body and the antenna pattern, and electrically connecting the antenna pattern to a feed point.
